(19) United States
(12) Patent Application Publication
(10) Pub. No.: US 2025/0080141 A1
(43) Pub. Date: Mar. 6, 2025

(54) RADIO FREQUENCY MODULE AND COMMUNICATION DEVICE

(71) Applicant: Murata Manufacturing Co., Ltd., Nagaokakyo-shi (JP)

(72) Inventors: Keisuke ARIMA, Nagaokakyo-shi (JP); Hiroyuki KANI, Nagaokakyo-shi (JP)

(73) Assignee: Murata Manufacturing Co., Ltd., Nagaokakyo-shi (JP)

(21) Appl. No.: 18/655,420

(22) Filed: May 6, 2024

(30) Foreign Application Priority Data
Aug. 29, 2023 (JP) 2023-139138

(51) Int. Cl. H04B 1/00

(52) U.S. Cl. CPC H04B 1/0057

(57) ABSTRACT

A radio frequency module includes a switch, first and second filters. The switch includes a common terminal and two selection terminals. A first communication path is connected to a first selection terminal. A second communication path is connected to a second selection terminal. The first filter is in the first communication path and includes first and second communication bands. The second filter is in the second communication path and includes third and fourth communication bands. At least a part of the third communication band overlaps the first communication band, but not the second communication band. The switch is switchable between first and second connections. In the first connection, the common terminal is connected to the first selection terminal. In the second connection, the common terminal is connected to the first selection terminal, and the common terminal is connected to the second the selection terminal.

### CROSS-REFERENCE TO RELATED APPLICATION

This application claims priority to Japanese Application No. 2023-139138, filed Aug. 29, 2023, the entire contents of which are hereby incorporated by reference.

### BACKGROUND

### 1. Field

The present disclosure relates to a radio frequency module and a communication device.

### 2. Description of the Related Art

A conventional switch module may include an antenna switch, a first filter, a second filter, and an impedance load circuit. The antenna switch includes a common terminal and first to third selection terminals. The first filter allows a signal in a first frequency band to pass therethrough. The first filter is connected between the first selection terminal of the antenna switch and a first reception signal amplifier circuit. The second filter allows a signal in a second frequency band to pass therethrough. The second filter is connected between the second selection terminal of the antenna switch and a second reception signal amplifier circuit. The impedance load circuit is connected between the third selection terminal of the antenna switch and the ground.

When communication is established by using both the first frequency band and second frequency band (i.e., in carrier aggregation (CA)), the common terminal of the antenna switch is connected with the first selection terminal and the second selection terminal. That is, a communication path in which the first filter is provided and a communication path in which the second filter is provided are connected to the common terminal of the antenna switch. On the other hand, when communication is established by using only the first frequency band (i.e., in non-CA), the common terminal of the antenna switch is connected with the first selection terminal and the third selection terminal. That is, the communication path in which the first filter is provided and a path in which the impedance load circuit is provided are connected to the common terminal of the antenna switch. Thus, in non-CA, the impedance characteristics of the communication path in non-CA is secured so as to be equivalent to the impedance characteristics in CA by connecting the path in which the impedance load circuit is provided to the communication path. Therefore, it is possible to reduce transmission loss of the communication path.

### SUMMARY

In the conventional switch module, the first filter only allows the signal in the first frequency band to pass therethrough; accordingly, there is no assumption that a frequency band other than the first frequency band is included in a pass band of the first filter. Therefore, there is no assumption to improve attenuation of a spurious wave in the first frequency band, which is along with a signal in the above-described other frequency band, when the frequency band other than the first frequency band is included in the pass band of the first filter in non-CA.

Additionally, since the switch module includes a dedicated path to provide the impedance load circuit, it is difficult to achieve size reduction.

Taking the above-described problems into consideration, an object of the present disclosure is to provide a radio frequency module and a communication device that can achieve both the improvement of attenuation of a spurious wave and size reduction.

A radio frequency module according to an aspect of the present disclosure includes a switch, a first communication path, a second communication path, a first filter, and a second filter. The switch includes a common terminal, a first selection terminal, and a second selection terminal. The first communication path is connected to the first selection terminal. The second communication path is connected to the second selection terminal. The first filter is provided in the first communication path and has a pass band including a first communication band and a second communication band different from the first communication band. The second filter is provided in the second communication path and has a pass band including a third communication band. At least a part of the third communication band overlaps the first communication band, and the third communication band does not overlap the second communication band. The switch is configured to be switchable between first connection and second connection. In the first connection, the common terminal is connected to the first selection terminal, and the common terminal is not connected to the second selection terminal. In the second connection, the common terminal is connected to the first selection terminal, and the common terminal is connected to the second selection terminal. The second communication band and the third communication band are configured so as not to be able to establish communication concurrently.

A communication device according to an aspect of the present disclosure includes the radio frequency module and a signal processing circuit. The signal processing circuit is connected to the radio frequency module and processes a radio frequency signal.

According to the radio frequency module and the communication device of the present disclosure, there is an advantage that it is possible to achieve both the improvement of attenuation of a spurious wave and size reduction.

### BRIEF DESCRIPTION OF THE DRAWINGS

FIG. 1 is a configuration diagram of a radio frequency module and a communication device according to an exemplary embodiment 1 and is an explanatory diagram describing an operation when receiving is performed by using a first communication band in the radio frequency module;

FIG. 2 is an explanatory diagram describing an operation when receiving is performed by using a second communication band in the radio frequency module;

FIG. 3 is a graph comparing attenuation of a spurious wave between the radio frequency module and a comparative example;

FIG. 4 is a configuration diagram of a radio frequency module and a communication device according to a modification 1 of the exemplary embodiment 1;

FIG. 5 is a configuration diagram of a radio frequency module and a communication device according to a modification 2 of the exemplary embodiment 1;

FIG. 6 is a configuration diagram of a radio frequency module and a communication device according to an exemplary embodiment 2 and is an explanatory diagram describing an operation when transmitting is performed by using the first communication band in the radio frequency module; and

FIG. 7 is an explanatory diagram describing an operation when transmitting is performed by using the second communication band in the radio frequency module.

### DESCRIPTION OF THE EXEMPLARY EMBODIMENTS

### Exemplary Embodiment 1

A radio frequency module 1 and a communication device 100 according to an exemplary embodiment 1 are described in detail with reference to the drawings.

### (1) Overview

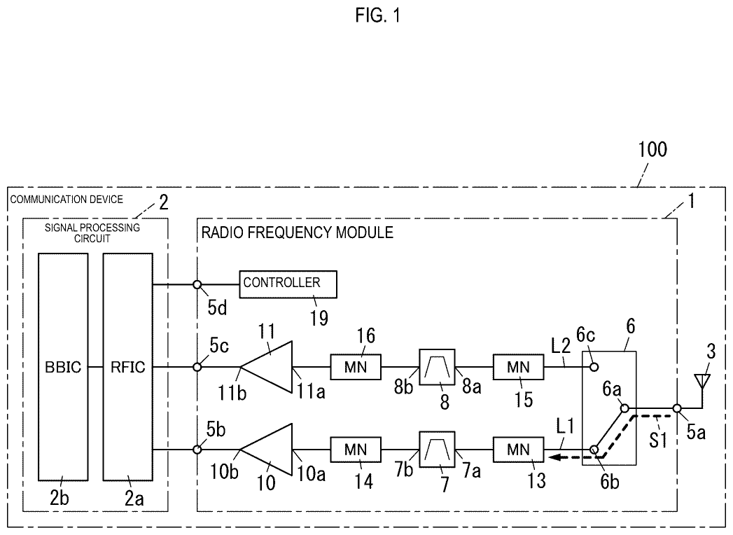

As illustrated in FIG. 1, the radio frequency module 1 according to the exemplary embodiment 1 includes a switch 6, a first communication path L1, a second communication path L2, a first filter 7, and a second filter 8. The switch 6 includes a common terminal 6a, a first selection terminal 6b, and a second selection terminal 6c. The first communication path L1 is connected to the first selection terminal 6b. The second communication path L2 is connected to the second selection terminal 6c. And the first filter 7 is provided in the first communication path L1 and has a pass band including a first communication band and a second communication band different from each other. The second filter 8 is provided in the second communication path L2 and has a pass band including a third communication band. A part of the third communication band overlaps the first communication band, and the third communication band does not overlap the second communication band. The switch 6 is configured to be switchable between first connection and second connection. In the first connection, the common terminal 6a and the first selection terminal 6b are connected to each other, and the common terminal 6a and the second selection terminal 6c are not connected to each other. In the second connection, the common terminal 6a and the first selection terminal 6b are connected to each other, and the common terminal 6a and the second selection terminal 6c are connected to each other. The second communication band and the third communication band are configured so as not to be able to establish communication concurrently.

According to this configuration, when the switch 6 selects the second connection, and communication (e.g., receiving) is established by using the second communication band, it is possible to disperse a part of a spurious wave in the first communication band, which is along with a signal in the second communication band being used in the communication, from the common terminal 6a to a second filter 8 side (a second communication path L2 side). To be more specific, in receiving, it is possible to disperse, from the common terminal 6a to a first filter 7 side (a first communication path L1 side) and to the second filter 8 side (the second communication path L2 side), the spurious wave included in a reception signal that arrives from an external terminal 5a at the common terminal 6a. Thus, when communication is established by using the second communication band, it is possible to reduce the above-described spurious wave, which is along with the signal in the second communication band being used in the communication, with the switch 6 selecting the second connection. That is, it is possible to sufficiently secure attenuation of the spurious wave, which is along with the signal being used in the communication. Note that, the spurious wave (also called a spurious radio wave) is an unnecessary radio wave that is radiated to the outside of a device when the device delivers radical operation and performance of the device.

Additionally, since a communication path (i.e., the second communication path L2 in which the second filter 8 is provided) used for communication of another communication band (the third communication band) different from the first communication band and the second communication band is also used as the path to secure attenuation of the above-described spurious wave as mentioned above, it is possible to reduce the radio frequency module 1 in size. As above, it is possible to achieve both the improvement of attenuation of the spurious wave and size reduction.

### (2) Configuration of Communication Device

As illustrated in FIG. 1, the communication device 100 is a communication device including the radio frequency module 1. The communication device 100 is, for example, a mobile terminal (e.g., a smartphone); however, it is not limited thereto and may be, for example, a wearable terminal (e.g., a smartwatch). The radio frequency module 1 is, for example, a module compatible with the fourth-generation mobile communications (4G) standard and the fifth-generation mobile communications (5G) standard. The 4G standard is, for example, the Third Generation Partnership Project (registered trademark, 3GPP) Long Term Evolution standard (registered trademark, LTE). The 5G standard is, for example, the 5G New Radio (NR).

The communication device 100 includes a signal processing circuit 2 and an antenna 3 in addition to the radio frequency module 1.

The radio frequency module 1 is configured to amplify a reception signal (a radio frequency signal) received by the antenna 3 and output the amplified reception signal to the signal processing circuit 2. Note that, the radio frequency module 1 may be configured to amplify a transmission signal (a radio frequency signal) outputted from the signal processing circuit 2 and transmit the amplified transmission signal from the antenna 3. For example, the radio frequency module 1 is controlled by the signal processing circuit 2.

The signal processing circuit 2 is connected to the radio frequency module 1 and is configured to perform signal processing on the reception signal outputted from the radio frequency module 1. The signal processing circuit 2 may be configured to perform signal processing on the transmission signal outputted to the radio frequency module 1. The signal processing circuit 2 includes a radio frequency (RF) signal processing circuit 2a and a baseband signal processing circuit 2b.

The RF signal processing circuit 2a is, for example, a radio frequency integrated circuit (RFIC) and performs signal processing on the radio frequency signal (the transmission signal and the reception signal). The RF signal processing circuit 2a performs signal processing such as downconversion on the reception signal outputted from the radio frequency module 1 and outputs the processed reception signal to the baseband signal processing circuit 2b. Note that, the RF signal processing circuit 2a may perform signal processing such as upconversion on the transmission signal outputted from the baseband signal processing circuit 2b and may output the processed transmission signal to the radio frequency module 1.

The baseband signal processing circuit 2b is, for example, a baseband integrated circuit (BBIC). The baseband signal processing circuit 2b outputs the reception signal outputted from the RF signal processing circuit 2a to the outside. This output signal (the reception signal) is, for example, used as an image signal to display an image or as an audio signal for voice calls. Additionally, the baseband signal processing circuit 2b may generate the transmission signal from a baseband signal (e.g., the audio signal and the image signal) inputted from the outside and may output the generated transmission signal to the RF signal processing circuit 2a.

### (3) Configuration of Radio Frequency Module

As illustrated in FIG. 1, the radio frequency module 1 includes multiple external terminals 5a to 5d, the switch 6, the first filter 7, the second filter 8, a first low noise amplifier 10 (a first amplifier), a second low noise amplifier 11 (a second amplifier), matching circuits 13 and 14 (a first matching circuit), matching circuits 15 and 16 (a second matching circuit), a controller 19, the first communication path L1, and the second communication path L2.

The external terminal 5a is an antenna terminal to which the antenna 3 is connected. The external terminals 5b and 5c are output terminals that are connected to an input unit (not illustrated) of the signal processing circuit 2 and output the reception signal processed by the radio frequency module 1 to the input unit of the signal processing circuit 2. The external terminal 5d is a signal input terminal that is connected to a signal output unit (not illustrated) of the signal processing circuit 2 and inputs a control signal to control the controller 19 from the signal processing circuit 2.

The switch 6 selects at least one signal path of the first communication path L1 and the second communication path L2 and connects the selected communication path with the antenna 3. The switch 6 is operated by a control signal from the controller 19. The switch 6 is, for example, a switch integrated circuit (IC). The switch 6 includes the common terminal 6a, the first selection terminal 6b, and the second selection terminal 6c. The common terminal 6a can be selectively connected with at least one of the first selection terminal 6b and the second selection terminal 6c. The common terminal 6a is connected to the external terminal 5a. The first selection terminal 6b is connected with the first communication path L1. The second selection terminal 6c is connected with the second communication path L2.

To be more specific, the switch 6 is configured to be switchable between the first connection and the second connection. The first connection is the connection between the common terminal 6a and the first selection terminal 6b, and the common terminal 6a and the second selection terminal 6c are not connected to each other. That is, in the first connection, the common terminal 6a is connected with the first selection terminal 6b but not connected with the second selection terminal 6c. The second connection is the connection between the common terminal 6a and the first selection terminal 6b and the connection between the common terminal 6a and the second selection terminal 6c. That is, in the second connection, the common terminal 6a is connected to both the first selection terminal 6b and second selection terminal 6c concurrently.

The first communication path L1 is the communication path connecting the first selection terminal 6b and the external terminal 5b to each other. In the first communication path L1, an output signal of the first selection terminal 6b is transmitted to the external terminal 5b. The second communication path L2 is the communication path connecting the second selection terminal 6c and the external terminal 5c to each other. In the second communication path L2, an output signal of the second selection terminal 6c is transmitted to the external terminal 5c.

The first filter 7 is a reception filter having the pass band including the first communication band and the second communication band. The first communication band is, for example, a Band 41. The Band 41 is a communication band with a band width of 2496 MHz to 2690 MHZ. The second communication band is a communication band different from the first communication band and is, for example, a Band 53. The Band 53 is a communication band with a band width of 2483.5 MHz to 2495 MHz. The second communication band may be adjacent to one stop band of the first communication band. The second communication band may be either greater or smaller than the first communication band. Additionally, the second communication band may overlap the first communication band. Here, “the second communication band overlaps the first communication band” means that a part of the second communication band overlaps at least a part of the first communication band or at least a part of the second communication band overlaps a part of the first communication band.

The first filter 7 is provided in the first communication path L1. That is, the first filter 7 is connected between the first selection terminal 6b of the switch 6 and the external terminal 5b.

The first filter 7 includes an input unit 7a and an output unit 7b. The input unit 7a is connected to the first selection terminal 6b of the switch 6 with the matching circuit 13 interposed therebetween. The output unit 7b is connected to an input unit 10a of the first low noise amplifier 10 with the matching circuit 14 interposed therebetween. The first filter 7 limits an input signal inputted to the input unit 7a to a signal in a reception band of the first communication band or a reception band of the second communication band to allow the signal to pass therethrough and outputs the reception signal that is allowed to pass therethrough from the output unit 7b.

The second filter 8 is a reception filter having the pass band including the third communication band. At least a part of the third communication band overlaps the first communication band, and the third communication band does not overlap the second communication band. The third communication band is, for example, a Band 7Rx (a reception band of a Band 7). The Band 7Rx is a communication band with a band width of 2620 MHz to 2690 MHz. The second filter 8 is provided in the second communication path L2. That is, the second filter 8 is connected between the second selection terminal 6c of the switch 6 and the external terminal 5c.

The second filter 8 includes an input unit 8a and an output unit 8b. The input unit 8a is connected to the second selection terminal 6c of the switch 6 with the matching circuit 15 interposed therebetween. The output unit 8b is connected to an input unit 11a of the second low noise amplifier 11 with the matching circuit 16 interposed therebetween. The second filter 8 limits an input signal inputted to the input unit 8a to a signal in a reception band of the third communication band to allow the signal to pass therethrough and outputs the reception signal that is allowed to pass therethrough from the output unit 8b.

The first low noise amplifier 10 is connected between the output unit 7b of the first filter 7 and the external terminal 5b in the first communication path L1. The first low noise amplifier 10 includes the input unit 10a and an output unit 10b. The input unit 10a is connected to the output unit 7b of the first filter 7 with the matching circuit 14 interposed therebetween. The output unit 10b is connected to the external terminal 5b. The first low noise amplifier 10 amplifies the reception signal inputted to the input unit 10a and outputs the amplified reception signal to the external terminal 5b from the output unit 10b.

The second low noise amplifier 11 is connected between the output unit 8b of the second filter 8 and the external terminal 5c in the second communication path L2. The second low noise amplifier 11 includes the input unit 11a and an output unit 11b. The input unit 11a is connected to the output unit 8b of the second filter 8 with the matching circuit 16 interposed therebetween. The output unit 11b is connected to the external terminal 5c. The second low noise amplifier 11 amplifies the reception signal inputted to the input unit 11a and outputs the amplified reception signal from the output unit 11b to the external terminal 5c.

The matching circuit 13 is provided between the first selection terminal 6b of the switch 6 and the first filter 7 in the first communication path L1. The matching circuit 13 is a circuit to match the impedance between the switch 6 and the first filter 7. For example, the matching circuit 13 includes an inductor connected to the first communication path L1 in series or an inductor connected between the first communication path L1 and the ground.

The matching circuit 14 is provided between the first filter 7 and the first low noise amplifier 10 in the first communication path L1. The matching circuit 14 is a circuit to match the impedance between the first filter 7 and the first low noise amplifier 10. For example, the matching circuit 14 includes an inductor connected to the first communication path L1 in series or an inductor connected between the first communication path L1 and the ground.

The matching circuit 15 is provided between the second selection terminal 6c of the switch 6 and the second filter 8 in the second communication path L2. The matching circuit 15 is a circuit to match the impedance between the switch 6 and the second filter 8. For example, the matching circuit 15 includes an inductor connected to the second communication path L2 in series or an inductor connected between the second communication path L2 and the ground.

The matching circuit 16 is provided between the second filter 8 and the second low noise amplifier 11 in the second communication path L2. The matching circuit 16 is a circuit to match the impedance between the second filter 8 and the second low noise amplifier 11. For example, the matching circuit 16 includes an inductor connected to the second communication path L2 in series or an inductor connected between the second communication path L2 and the ground.

The controller 19 controls an electronic component (e.g., the switch 6, the first low noise amplifier 10, the second low noise amplifier 11, and so on) included in the radio frequency module 1 according to the control signal from the signal processing circuit 2. The controller 19 is electrically connected with the above-described electronic component. Additionally, the controller 19 is connected to the signal output unit of the signal processing circuit 2 with the external terminal 5d interposed therebetween. The controller 19 controls each above-described electronic component according to the control signal inputted from the signal output unit of the signal processing circuit 2 to the external terminal 5d.

### (4) Operation

An operation of the radio frequency module 1 is described. In the exemplary embodiment 1, it is assumed that the second communication band and the third communication band are configured so as not to be able to establish communication concurrently. Additionally, it is assumed that the first communication band and the second communication band are configured so as not to be able to establish communication concurrently.

(4-1) Operation when Communication (i.e., Receiving) is Established by Using First Communication Band

A case where receiving is performed by using the first communication band is considered with reference to FIG. 1. In this case, as described above, since the first communication band and the second communication band are configured so as not to be able to establish communication concurrently, the signal used in the communication (the reception signal) does not include the signal in the second communication band.

In this case (when receiving is performed by using the first communication band), the switch 6 is switched to the first connection. In the first connection, the common terminal 6a is connected to only the first selection terminal 6b out of the first selection terminal 6b and the second selection terminal 6c. Thus, a reception signal S1 received by the antenna 3 flows from the common terminal 6a to the first selection terminal 6b but does not flow to the second selection terminal 6c. Then, the reception signal S1 flows from the first selection terminal 6b to the external terminal 5b through the first communication path L1. Accordingly, the reception signal S1 passes through the matching circuit 13, the first filter 7, the matching circuit 14, and the first low noise amplifier 10 in sequence. In this case, the reception signal S1 is limited to the signal in the first communication band and the second communication band by the first filter 7. To be more specific, in this case (a case where communication is established by using the first communication band), since the reception signal S1 does not include the signal in the second communication band as the signal used in the communication, the reception signal S1 is limited to the signal in the first communication band. Then, the reception signal S1 is amplified by the first low noise amplifier 10. Then, the reception signal S1 is outputted from the external terminal 5b to the signal processing circuit 2.

In this operation description, it is assumed that the band width of the second communication band is sufficiently smaller than the band width of the first communication band. Under this assumption, the spurious wave in the second communication band, which is along with the signal in the first communication band being used in the communication, is small enough to be ignored.

Thus, when receiving is performed by using the first communication band, the reception signal S1 limited to the signal in the first communication band by the first filter 7 flows through the first communication path L1.

(4-2) Operation when Communication (e.g., Receiving) is Established by Using Second Communication Band

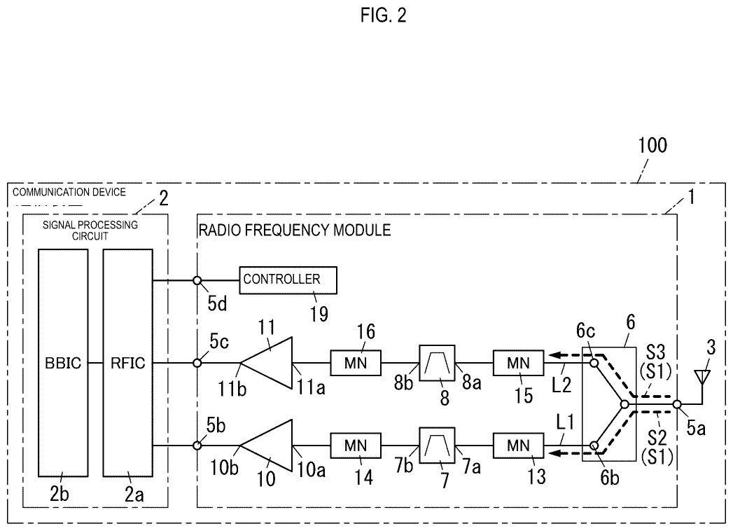

A case where receiving is performed by using the second communication band is considered with reference to FIG. 2. In this case, the switch 6 is switched to the second connection. In the second connection, the common terminal 6a is connected to both the first selection terminal 6b and second selection terminal 6c. Thus, the reception signal S1 received by the antenna 3 can flow from the common terminal 6a to the first communication path L1 through the first selection terminal 6b and can also flow from the common terminal 6a to the second communication path L2 through the second selection terminal 6c.

Incidentally, at least a part of the third communication band overlaps the first communication band, but the third communication band does not overlap the second communication band. Therefore, a signal S2 in the second communication band that is included in the reception signal S1 can pass through the first filter 7 having the pass band that includes the second communication band but cannot pass through the second filter 8 having the pass band that does not include the second communication band. Therefore, the signal S2 in the second communication band that is included in the reception signal S1 flows to the first filter 7 side (i.e., the first communication path L1) without flowing to the second filter 8 side (i.e., the second communication path L2). Then, the reception signal S1 is limited to the signal in the first communication band and the signal in the second communication band by the first filter 7 and amplified by the first low noise amplifier 10 in the first communication path L1.

Incidentally, the first communication band and the second communication band are configured so as not to be able to establish communication concurrently. Therefore, in this case (when communication is established by using the second communication band), the reception signal S1 may include a spurious wave S3 in the first communication band although it does not include the signal in the first communication band as the signal used in the communication. The spurious wave S3 in the first communication band that is included in the reception signal S1 can pass through both the first filter 7 having the pass band including the first communication band and the second filter 8 having the pass band including the third communication band in which at least a part thereof overlaps the first communication band. Therefore, the spurious wave S3 in the first communication band that is included in the reception signal S1 flows dispersedly to the first filter 7 side (i.e., the first communication path L1) and the second filter 8 side (i.e., the second communication path L2). That is, since a part of the spurious wave S3 in the first communication band that is included in the reception signal S1 is dispersed to the second communication path L2, the spurious wave S3 in the first communication band that is included in the reception signal S1 flowing through the first communication path L1 is accordingly reduced.

Thus, when communication (e.g., receiving) is established by using the second communication band, the signal S2 in the second communication band that is included in the reception signal S1 flows only to the first communication path L1 out of the first communication path L1 and the second communication path L2. On the other hand, the spurious wave S3 in the first communication band that is included in the reception signal S1 flows dispersedly to both the first communication path L1 and second communication path L2. Thus, it is possible to reduce the spurious wave S3 in the first communication band, which flows along with the signal S2 in the second communication band, in the first communication path L1. That is, it is possible to sufficiently secure attenuation of the spurious wave S3 in the first communication band, which is along with the signal in the second communication band being used in the communication. Thus, it is possible to reduce the above-described spurious wave, which is along with the signal S2 in the second communication band, and therefore it is possible to expand the pass band of the first filter 7 to include the second communication band.

### (5) About Interference Wave in OOB Blocking Range 3 of Second Communication Band

With the radio frequency module 1, it is possible to reduce an interference wave in an out-of-band (OOB) blocking Range 3 of the second communication band (the Band 53) as the above-described spurious wave. When communication is established by using the 3GPP communication standard or, for example, when communication is established by using the second communication band (the Band 53), it is necessary to reduce the interference wave in the OOB blocking Range 3 of the second communication band (the Band 53) to a certain level.

Note that, the interference wave (also called an interference radio wave) is a weak radio wave emitted from an electronic device and is a radio wave that interferes an operation of another electronic device and causes an obstruction. The interference wave is a radio wave that is substantially the same type as that of the above-described spurious wave.

Here, the OOB blocking Range 3 of a communication band (e.g., the second communication band) is a frequency range in which a predetermined band (+85 MHz to +12.75 GMHz) is added to an upper limit frequency of the communication band and a frequency range in which a predetermined band (−12.75 GMHz to −85 MHz) is added to a lower limit frequency of the communication band. That is, there are two above-described Ranges 3 in total on an upper limit frequency side and a lower limit frequency side of the communication band. In the exemplary embodiment 1, as described later, when the first communication band (the Band 41) and the second communication band (the Band 53) are co-banded, a part of the above-described Range 3 of the second communication band (to be more specific, the Range3 on the upper limit frequency side of the second communication band) is included in the first communication band, and therefore it is necessary to consider reducing the interference wave included in the above-described Range 3 of the second communication band. Note that, above-described “co-banding” is processing of signals in multiple communication bands in the same communication path.

In the exemplary embodiment 1, in the pass band of the first filter 7, a low frequency side of the first communication band (the Band 41) is expanded to include the second communication band (the Band 53). A part of the above-described Range 3 of the second communication band is included in the first communication band (the Band 41). Therefore, the pass band of the first filter 7 includes a part of the above-described Range 3 of the second communication band with the second communication band. Accordingly, the first filter 7 allows also the interference wave in the above-described Range 3 of the second communication band to pass therethrough when it allows the signal in the second communication band to pass therethrough.

In contrast, in the exemplary embodiment 1, when communication (i.e., receiving) is established by using the second communication band, the switch 6 is connected to the second connection as illustrated in FIG. 2. That is, the common terminal 6a of the switch 6 is connected to the first communication path L1 (i.e., the communication path in which the first filter 7 is provided) with the first selection terminal 6b interposed therebetween and is also connected to the second communication path L2 (i.e., the communication path in which the second filter 8 is provided) with the second selection terminal 6c interposed therebetween. The second filter 8 has the pass band including the third communication band (the Band 7Rx). The third communication band is the communication band in which at least a part thereof overlaps the first communication band (the Band 41) but does not overlap the second communication band (the Band 53).

Therefore, when communication is established by using the second communication band, the interference wave in the above-described Range 3 of the second communication band flows dispersedly to both the first communication path L1 and second communication path L2 as with the above-described spurious wave. Thus, when the signal S2 in the second communication band that is included in the reception signal S1 flows to the first communication path L1, it is possible to reduce the interference wave in the above-described Range 3 of the second communication band flowing to the first communication path L1. That is, it is possible to sufficiently secure attenuation of the interference wave in the above-described Range 3, which is along with the second communication band being used in the communication. Thus, it is possible to reduce the interference wave in the above-described Range 3 of the second communication band (the Band 53), and therefore it is possible to expand the pass band of the first filter 7 to include the second communication band.

### (6) Supplementary Description of Exemplary Embodiment 1

Supplementary description of the exemplary embodiment 1 is provided. In the exemplary embodiment 1, the second communication band (the Band 53) is co-banded with the first communication band (the Band 41) in the first filter 7. In the exemplary embodiment 1, the pass band of the first filter 7 that is a target of the co-banding includes the communication band (the Band 41) having a pass band of a band width of 85 MHz or greater as the first communication band (supplement 1). Additionally, the first communication band (the Band 41) includes the third communication band (the Band 7Rx) included in the pass band of the second filter 8, which is a filter different from the first filter 7 (supplement 2). Moreover, the third communication band (the Band 7Rx) includes a band (e.g., a band of 2581 MHz or greater) of the above-described Range 3 of the second communication band co-banded with the first communication band (supplement 3).

According to the supplements 1 to 3, it is possible to include the above-described Range 3 of the second communication band in the pass bands of both the first filter 7 and the second filter 8. Thus, when communication is established by using the second communication band, it is possible to cause the interference wave in the above-described Range 3 of the second communication band dispersedly to flow to the first communication path L1 and the second communication path L2 by connecting the switch 6 to the second connection.

### (7) Comparative Example

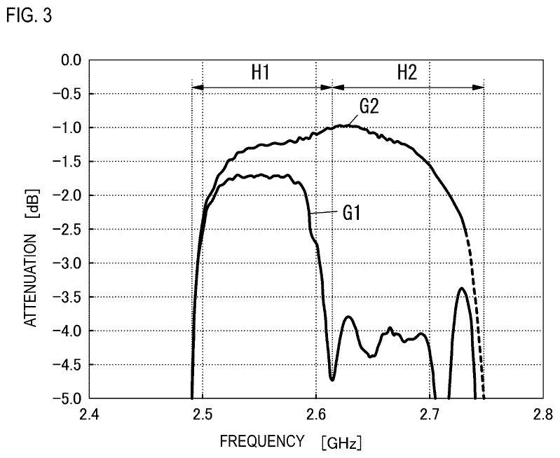

FIG. 3 is a graph comparing the frequency characteristics of the signal flowing through the first communication path L1 when communication is established by using the second communication band between a case of the exemplary embodiment 1 (a graph G1) and a comparative example (a graph G2). The horizontal axis of FIG. 3 is a frequency [GHz] of the signal flowing through the first communication path L1, and the vertical axis of FIG. 3 is attenuation [dB] of the signal flowing through the first communication path L1.

A radio frequency module according to the comparative example has a similar configuration to that of the radio frequency module 1 according to the exemplary embodiment 1 except that the switch 6 is connected to the first connection when communication is established by using the second communication band. In the comparative example, when communication is established by using the second communication band, the switch 6 is connected to the first connection, and the common terminal 6a of the switch 6 is connected to only the first selection terminal 6b. Thus, in the comparative example, both the signal in the second communication band and the interference wave in the above-described Range 3 of the second communication band pass through the first communication path L1 with no attenuation. Therefore, as illustrated in the graph G2 in FIG. 3, in the comparative example, the frequency characteristics of the signal flowing through the first communication path L1 are the frequency characteristics having a high signal strength (i.e., a small attenuation) over a range including both a frequency range H1 of the second communication band and a frequency range H2 of the above-described Range 3 of the second communication band.

In the exemplary embodiment 1, as described above, the switch 6 is connected to the second connection when communication is established by using the second communication band. Thus, as described above, the signal in the second communication band passes through the first communication path L1 with no attenuation, and the interference wave in the above-described Range 3 of the second communication band passes through the first communication path L1 with attenuation. Therefore, as illustrated in the graph G1 in FIG. 3, in the exemplary embodiment 1, the frequency characteristics of the signal flowing through the first communication path L1 are the frequency characteristics having a signal strength that does not attenuate (i.e., attenuation is small) in the frequency range H1 in the second communication band as with the comparative example but that attenuates considerably (i.e., attenuation is great) in the frequency range H2 of the above-described Range 3 of the second communication band compared with the comparative example.

According to the graphs G1 and G2 in FIG. 3, it can be seen that, in the exemplary embodiment 1 compared with the comparative example, the frequency characteristics of the signal flowing through the first communication path L1 has almost no change in the frequency range H1 in the second communication band but attenuates sufficiently in the frequency range H2 of the above-described Range 3 of the second communication band.

### (8) About Size Reduction of Radio Frequency Module

The second communication path L2 is the communication path used to transmit the reception signal received by the antenna 3 from the second selection terminal 6c of the switch 6 to the external terminal 5c when communication (e.g., receiving) is established by using the third communication band. As mentioned above, when the spurious wave S3 is dispersed to a path (the second communication path L2) other than the first communication path L1, the dispersion is performed by using the second communication path L2, which is the communication path used for the communication of the third communication band different from the first communication band and the second communication band. That is, the second communication path L2 is used not only as the communication path to transmit the signal used for the communication but also as a dispersion path to disperse the spurious wave S3. Therefore, in the radio frequency module 1, since the above-described communication path (the second communication path L2) is also used as the above-described dispersion path, it is possible to reduce the radio frequency module 1 in size accordingly.

### (9) Effect

As above, the radio frequency module 1 according to the exemplary embodiment 1 includes the switch 6, the first communication path L1, the second communication path L2, the first filter 7, and the second filter 8. The switch 6 includes the common terminal 6a, the first selection terminal 6b, and the second selection terminal 6c. The first communication path L1 is connected to the first selection terminal 6b. The second communication path L2 is connected to the second selection terminal 6c. The first filter 7 is provided in the first communication path L1 and has the pass band including the first communication band and the second communication band different from each other. The second filter 8 is provided in the second communication path L2 and has the pass band including the third communication band. At least a part of the third communication band overlaps the first communication band, and the third communication band does not overlap the second communication band. The switch 6 is configured to be switchable between the first connection and the second connection. In the first connection, the common terminal 6a and the first selection terminal 6b are connected to each other, and the common terminal 6a and the second selection terminal 6c are not connected to each other. In the second connection, the common terminal 6a and the first selection terminal 6b are connected to each other, and the common terminal 6a and the second selection terminal 6c are connected to each other. The second communication band and the third communication band are configured so as not to be able to establish communication concurrently.

According to this configuration, when the switch 6 selects the second connection, and when communication (e.g., receiving) is established by using the second communication band, it is possible to disperse a part of the spurious wave S3 in the first communication band, which is along with the signal S2 in the second communication band being used in the communication, from the common terminal 6a to the second filter 8 side (the second communication path L2 side). Thus, when communication is established by using the second communication band, it is possible to reduce the spurious wave S3, which is along with the signal S2 in the second communication band being used in the communication, with the switch 6 selecting the second connection. That is, it is possible to sufficiently secure attenuation of the spurious wave S3, which is along with the signal being used in the communication.

Additionally, since the communication path (i.e., the second communication path L2 in which the second filter 8 is provided) used for the communication of the third communication band different from the first communication band and the second communication band is also used as the path to secure attenuation of the spurious wave S3 as mentioned above, it is possible to reduce the radio frequency module 1 in size. As above, it is possible to achieve both the improvement of attenuation of the spurious wave S3 and size reduction in the radio frequency module 1.

Moreover, in the radio frequency module 1 according to the exemplary embodiment 1, as mentioned above, the second communication band and the third communication band are configured so as not to be able to establish communication concurrently.

According to this configuration, when communication is established by using the second communication band, it is possible to disperse a part of the spurious wave S3 in the first communication band, which is along with the signal S2 in the second communication band being used in the communication, to the second filter 8 side that is not being used in the communication. Thus, it is possible to reduce a negative effect of the spurious wave S3 dispersed to the second filter 8 side on the communication using the second communication band.

Furthermore, in the radio frequency module 1 according to the exemplary embodiment 1, the first communication band and the second communication band are configured so as not to be able to establish communication concurrently.

According to this configuration, since it is possible to use the filter (the first filter 7) having the pass band including the first communication band and the filter (the first filter 7) having the pass band including the second communication band as one filter, it is possible to implement size reduction of the radio frequency module 1. Additionally, when communication is established by using the second communication band, even if a part of the signal in the first communication band, which is along with the signal S2 in the second communication band being used in the communication, is dispersed to the second filter 8 side as the spurious wave S3, it is possible to reduce a negative effect on the communication using the first communication band.

Additionally, the radio frequency module 1 according to the exemplary embodiment 1 further includes the first low noise amplifier 10 (the first amplifier). The first low noise amplifier 10 is provided on the opposite side of the first filter 7 from the switch 6 in the first communication path L1. That is, the reception signal passes through the switch 6, the first filter 7, and the first low noise amplifier 10 in this order.

According to this configuration, it is possible to achieve the effects of improvement of attenuation of the spurious wave S3 and size reduction described above in the configuration in which the first low noise amplifier 10 is provided in the first communication path L1.

Moreover, the radio frequency module 1 according to the exemplary embodiment 1 further includes the second low noise amplifier 11 (the second amplifier). The second low noise amplifier 11 is provided on the opposite side of the second filter 8 from the switch 6 in the second communication path L2. That is, the reception signal passes through the switch 6, the second filter 8, and the second low noise amplifier 11 in this order.

According to this configuration, it is possible to achieve the effects of improvement of attenuation of the spurious wave S3 and size reduction described above in the configuration in which the second low noise amplifier 11 is provided in the second communication path L2.

Furthermore, the radio frequency module 1 according to the exemplary embodiment 1 further includes the matching circuits 13 and 14 (the first matching circuit). The matching circuits 13 and 14 are provided in at least one of (in the exemplary embodiment 1, both) a portion between the switch 6 and the first filter 7 and a portion between the first filter 7 and the first low noise amplifier 10 (the first amplifier) in the first communication path L1. Although both the matching circuits 13 and 14 are provided in the exemplary embodiment 1, a configuration in which at least one of the matching circuits 13 and 14 is provided may be applicable.

According to this configuration, it is possible to adjust the impedance characteristics of the first communication path L1 by the matching circuits 13 and 14. Thus, when the switch 6 selects the second connection, it is possible to adjust a ratio of a part of the spurious wave S3 in the first communication band that is dispersed to the second filter 8 side.

Additionally, the radio frequency module 1 according to the exemplary embodiment 1 further includes the matching circuits 15 and 16 (the second matching circuit). The matching circuits 15 and 16 are provided in at least one of (in the exemplary embodiment 1, both) a portion between the switch 6 and the second filter 8 and a portion between the second filter 8 and the second low noise amplifier 11 (the second amplifier) in the second communication path L2. Although both the matching circuits 15 and 16 are provided in the exemplary embodiment 1, a configuration in which at least one of the matching circuits 15 and 16 is provided may be applicable.

According to this configuration, it is possible to adjust the impedance characteristics of the second communication path L2 by the matching circuits 15 and 16. Thus, when the switch 6 selects the second connection, it is possible to adjust a ratio of a part of the spurious wave S3 in the first communication band that is dispersed to the second filter 8 side.

Moreover, in the radio frequency module 1 according to the exemplary embodiment 1, the first communication band is the Band 41. The second communication band is the Band 53. The third communication band is the reception band of the Band 7.

According to this configuration, when the first communication band is the Band 41, the second communication band is the Band 53, and the third communication band is the reception band of the Band 7, it is possible to achieve both the improvement of attenuation of the spurious wave S3 and size reduction described above. Particularly, since the third communication band is the reception band of the Band 7, it is possible to improve attenuation of the interference wave in the OOB blocking Range 3 as the spurious wave S3.

Furthermore, the communication device 100 according to the exemplary embodiment 1 includes the radio frequency module 1 and the signal processing circuit 2. The signal processing circuit 2 is connected to the radio frequency module 1 and processes the radio frequency signal.

According to this configuration, it is possible to provide the communication device 100 that achieves the above-described effects of the radio frequency module 1.

### (10) Modifications

Modifications of the exemplary embodiment 1 are described. In the descriptions below, a reference sign same as that in a case of the exemplary embodiment 1 may be provided to a constituent same as that in the exemplary embodiment 1 to omit the description, and only a portion different from the exemplary embodiment 1 may be described. Additionally, the following modifications may be implemented in combination.

### (10-1) Modification 1

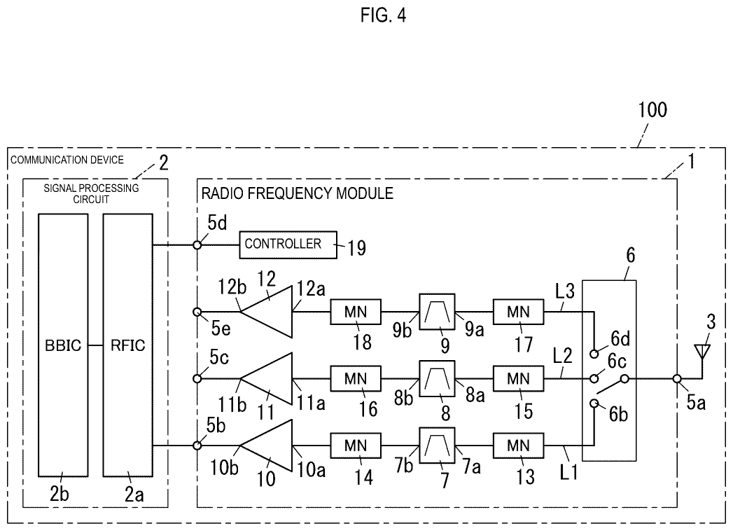

The exemplary embodiment 1 exemplifies a case where the radio frequency module 1 includes two filters (the first filter 7 and the second filter 8). In contrast, as illustrated in FIG. 4, a modification 1 exemplifies a case where the radio frequency module 1 includes three or more (e.g., three) filters (first to third filters 7 to 9).

As illustrated in FIG. 4, the modification 1 is different from the embodiment 1 in that the switch 6 further includes a third selection terminal 6d. Additionally, the modification 1 is different from the embodiment 1 in that the radio frequency module 1 further includes a third communication path L3, the third filter 9, a third low noise amplifier 12, matching circuits 17 and 18, and an external terminal 5e. Except these points, the configuration of the modification 1 is similar to that of the embodiment 1.

The external terminal 5e is an output terminal that is connected to the input unit (not illustrated) of the signal processing circuit 2 and outputs the reception signal processed by the radio frequency module 1 to the input unit of the signal processing circuit 2.

The third selection terminal 6d of the switch 6 is connected with the third communication path L3. The common terminal 6a of the switch 6 can be selectively connected with at least one of the first to third selection terminals 6b to 6d of the switch 6. To be more specific, the switch 6 is also configured to be switchable to third connection in addition to the first connection and the second connection. The third connection is connection between the common terminal 6a and the third selection terminal 6d. In the exemplary embodiment 1, in the third connection, as an example, the common terminal 6a is not connected with the first selection terminal 6b and the second selection terminal 6c.

The third communication path L3 is a communication path to connect the third selection terminal 6d and the external terminal 5e to each other.

The third filter 9 is, for example, a reception filter having a pass band including a fourth communication band. The fourth communication band is, for example, a Band 40. The Band 40 is a communication band with a band width of 2300 MHz to 2400 MHZ. The third filter 9 is provided in the third communication path L3. That is, the third filter 9 is connected between the third selection terminal 6d of the switch 6 and the external terminal 5e.

The third filter 9 includes an input unit 9a and an output unit 9b. The input unit 9a is connected to the third selection terminal 6d of the switch 6 with the matching circuit 17 interposed therebetween. The output unit 9b is connected to an input unit 12a of the third low noise amplifier 12 with the matching circuit 18 interposed therebetween. The third filter 9 limits an input signal inputted to the input unit 9a to a signal in a reception band of the fourth communication band to allow the signal to pass therethrough and outputs the reception signal that is allowed to pass therethrough from an output unit 12b.

The third low noise amplifier 12 is connected between the output unit 9b of the third filter 9 and the external terminal 5e in the third communication path L3. The third low noise amplifier 12 includes the input unit 12a and the output unit 12b. The input unit 12a is connected to the output unit 9b of the third filter 9 with the matching circuit 18 interposed therebetween. The output unit 12b is connected to the external terminal 5e. The third low noise amplifier 12 amplifies the reception signal inputted to the input unit 12a and outputs the amplified reception signal from the output unit 12b.

The matching circuit 17 is provided between the third selection terminal 6d of the switch 6 and the third filter 9 in the third communication path L3. The matching circuit 17 is a circuit to match the impedance between the switch 6 and the third filter 9. For example, the matching circuit 17 includes an inductor connected to the third communication path L3 in series or an inductor connected between the third communication path L3 and the ground.

The matching circuit 18 is provided between the third filter 9 and the third low noise amplifier 12 in the third communication path L3. The matching circuit 18 is a circuit to match the impedance between the third filter 9 and the third low noise amplifier 12. For example, the matching circuit 18 includes an inductor connected to the third communication path L3 in series or an inductor connected between the third communication path L3 and the ground.

According to the modification 1, since the three or more (e.g., three) filters (the first to third filters 7 to 9) are included, when three or more (i.e., many) communication bands are included, it is possible to achieve both the improvement of attenuation of the spurious wave and size reduction as with the exemplary embodiment 1.

### (10-2) Modification 2

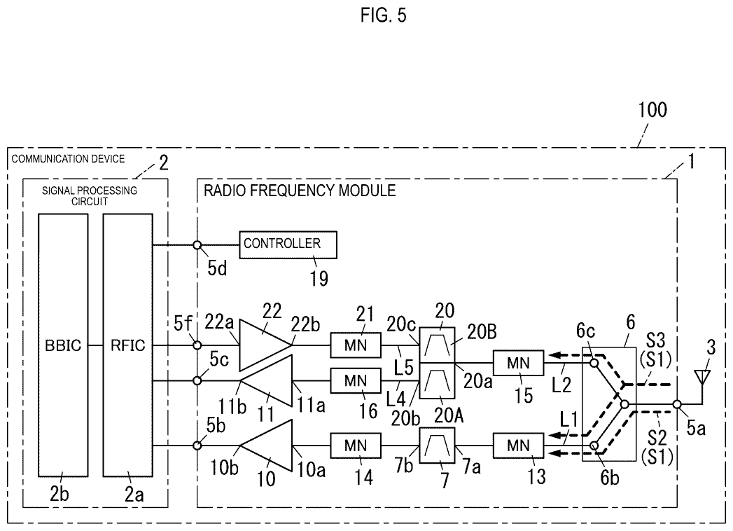

As illustrated in FIG. 5, a modification 2 is different from the exemplary embodiment 1 in that a second filter 20 is a frequency division duplex (FDD) filter. Additionally, the modification 2 is different from the exemplary embodiment 1 in that the radio frequency module 1 further includes a power amplifier 22, a matching circuit 21, an external terminal 5f, a fourth communication path L4, and a fifth communication path L5. Except these points, the configuration of the modification 2 is similar to that of the exemplary embodiment 1.

The external terminal 5f is an input terminal that is connected to the output unit (not illustrated) of the signal processing circuit 2 and inputs the transmission signal outputted from the output unit of the signal processing circuit 2 to the radio frequency module 1.

The second communication path L2 of the modification 2 connects the second selection terminal 6c of the switch 6 with a later-described input-output unit 20a of the second filter 20. The fourth communication path L4 connects a later-described output unit 20b of the second filter 20 with the external terminal 5c. The fifth communication path L5 connects a later-described input unit 20c of the second filter 20 with the external terminal 5f.

The second filter 20 is an FDD filter having the third communication band that is a reception band for FDD and a fifth communication band that is a transmission band for FDD. To be more specific, the second filter 20 is a transmission-reception filter that includes a reception filter 20A having the reception band including the third communication band and a transmission filter 20B having the transmission band including the fifth communication band. The third communication band is a communication band for reception (e.g., the Band 7RX) similar to the third communication band in the exemplary embodiment 1. The fifth communication band is a communication band (i.e., a communication band that does not overlap the third communication band) different from the third communication band and is a communication band for transmission (e.g., a Band 7Tx).

The second filter 20 includes the input-output unit 20a, the output unit 20b, and the input unit 20c. The input-output unit 20a is connected to the second selection terminal 6c of the switch 6 with the matching circuit 15 interposed therebetween. The output unit 20b is connected to the external terminal 5c with the fourth communication path L4 interposed therebetween. The input unit 20c is connected to the external terminal 5f with the fifth communication path L5 interposed therebetween.

The reception filter 20A limits an input signal (the reception signal or the spurious wave) inputted to the input-output unit 20a to a signal in the reception band of the third communication band to allow the signal to pass therethrough and outputs the input signal that is allowed to pass therethrough from the output unit 20b. The transmission filter 20B limits an input signal (the transmission signal) inputted to the input unit 20c to a signal in the transmission band of the fifth communication band to allow the signal to pass therethrough and outputs the input signal that is allowed to pass therethrough from the input-output unit 20a.

The second low noise amplifier 11 and the matching circuit 16 are provided in the fourth communication path L4. The configurations of the second low noise amplifier 11 and the matching circuit 16 are similar to those in the exemplary embodiment 1. The input unit 11a of the second low noise amplifier 11 is connected to the output unit 20b of the second filter 20 with the matching circuit 16 interposed therebetween. The output unit 11b of the second low noise amplifier 11 is connected to the external terminal 5c. The matching circuit 16 is provided between the second low noise amplifier 11 and the reception filter 20A in the fourth communication path L4 and matches the impedance between the second low noise amplifier 11 and the reception filter 20A.

The power amplifier 22 and the matching circuit 21 are provided in the fifth communication path L5.

The power amplifier 22 includes an input unit 22a and an output unit 22b. The input unit 22a is connected to the external terminal 5f. The output unit 22b is connected to the input unit 20c of the second filter 20 with the matching circuit 21 interposed therebetween. The power amplifier 22 amplifies the transmission signal inputted to the input unit 22a and outputs the amplified transmission signal from the output unit 22b.

The matching circuit 21 is provided between the transmission filter 20B and the power amplifier 22 in the fifth communication path L5. The matching circuit 21 is a circuit to match the impedance between the transmission filter 20B and the power amplifier 22. For example, the matching circuit 21 includes an inductor connected to the fifth communication path L5 in series or an inductor connected between the fifth communication path L5 and the ground.

According to the modification 2, when the second filter 20 is the FDD filter, it is possible to achieve both the improvement of attenuation of the spurious wave and size reduction as with the exemplary embodiment 1.

### Exemplary Embodiment 2

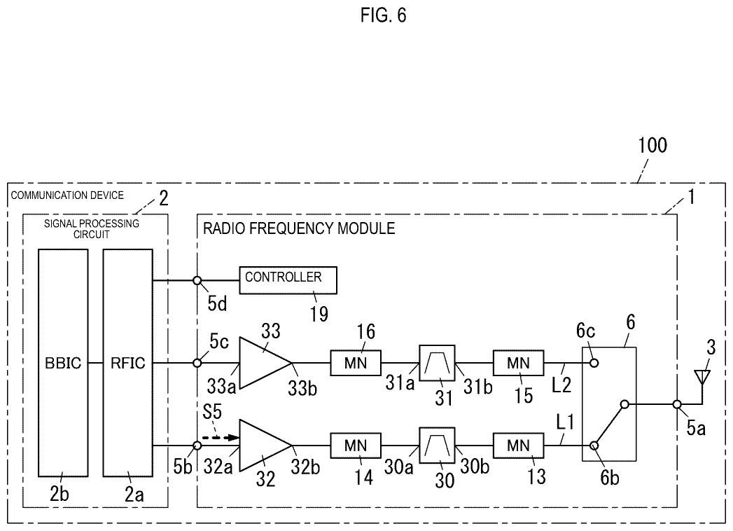

The radio frequency module 1 according to an exemplary embodiment 2 is described with reference to FIG. 6. In the descriptions below, a reference sign same as that in a case of the exemplary embodiment 1 may be provided to a constituent same as that in the exemplary embodiment 1 to omit the description, and only a portion different from the exemplary embodiment 1 may be described.

### (1) Configuration

The exemplary embodiment 2 exemplifies a case where a first filter 30 and a second filter 31 are transmission filters.

As illustrated in FIG. 6, the configuration of the radio frequency module 1 according to the exemplary embodiment 2 is similar to that of the radio frequency module 1 of the exemplary embodiment 1 except that the first filter 30 and the second filter 31 are the transmission filters, and the first amplifier and the second amplifier are a first power amplifier 32 and a second power amplifier 33, respectively.

In the exemplary embodiment 2, the external terminals 5b and 5c are input terminals that are connected to the output unit (not illustrated) of the signal processing circuit 2 and input the transmission signal outputted from the output unit of the signal processing circuit 2 to the radio frequency module 1.

The first filter 30 is a transmission filter having a pass band including the first communication band and the second communication band. The first communication band is, for example, a Band 12Tx (a transmission band of a Band 12). The Band 12Tx is a communication band with a band width of 699 MHz to 716 MHZ. The second communication band is a communication band different from the first communication band and is, for example, a Band 71Tx (a transmission band of a Band 71). The Band 71Tx is a communication band with a band width of 663 MHz to 698 MHz. The second communication band may be either greater or smaller than the first communication band. Additionally, the second communication band may overlap the first communication band. The first filter 30 is provided in the first communication path L1. That is, the first filter 30 is connected between the first selection terminal 6b of the switch 6 and the external terminal 5b.

The first filter 30 includes an input unit 30a and an output unit 30b. The output unit 30b is connected to the first selection terminal 6b of the switch 6 with the matching circuit 13 interposed therebetween. The input unit 30a is connected to an output unit 32b of the first power amplifier 32 with the matching circuit 14 interposed therebetween. The first filter 30 limits an input signal (the transmission signal) inputted to the input unit 30a to a signal in the transmission band of the first communication band or a signal in the transmission band of the second communication band to allow the signal to pass therethrough and outputs the transmission signal that is allowed to pass therethrough from the output unit 30b.

The second filter 31 is a transmission filter having a pass band including the third communication band. A part of the third communication band overlaps the first communication band, and the third communication band does not overlap the second communication band. The third communication band is, for example, Tx of a Band 28A (a transmission band of the Band 28A) or Tx of a Band 28B (a transmission band of the Band 28B). Tx of the Band 28A is a communication band with a band width of 703 MHz to 733 MHz. Tx of the Band 28B is a communication band with a band width of 718 MHz to 748 MHz. The second filter 31 is provided in the second communication path L2. That is, the second filter 31 is connected between the second selection terminal 6c of the switch 6 and the external terminal 5c.

The second filter 31 includes an input unit 31a and an output unit 31b. The output unit 31b is connected to the second selection terminal 6c of the switch 6 with the matching circuit 15 interposed therebetween. The input unit 31a is connected to the external terminal 5c with the matching circuit 16 interposed therebetween. The second filter 31 limits an input signal (the transmission signal) inputted to the input unit 31a to a signal in the reception band of the third communication band to allow the signal to pass therethrough and outputs the reception signal that is allowed to pass therethrough from the output unit 31b.

The first power amplifier 32 is connected between the first filter 30 and the external terminal 5b in the first communication path L1. The first power amplifier 32 includes an input unit 32a and the output unit 32b. The input unit 32a is connected to the external terminal 5b. The output unit 32b is connected to the input unit 30a of the first filter 30 with the matching circuit 14 interposed therebetween. The first power amplifier 32 amplifies the transmission signal inputted to the input unit 32a and outputs the amplified transmission signal from the output unit 32b.

The second power amplifier 33 is connected between the second filter 31 and the external terminal 5c in the second communication path L2. The second power amplifier 33 includes an input unit 33a and an output unit 33b. The input unit 33a is connected to the external terminal 5c. The output unit 33b is connected to the input unit 31a of the second filter 31 with the matching circuit 16 interposed therebetween. The second power amplifier 33 amplifies the transmission signal inputted to the input unit 33a and outputs the amplified transmission signal from the output unit 33b.

In the exemplary embodiment 2, the matching circuit 13 is connected between the switch 6 and the first filter 30 and matches the impedance between the switch 6 and the first filter 30. The matching circuit 14 is connected between the first power amplifier 32 and the first filter 30 and matches the impedance between the first power amplifier 32 and the first filter 30. The matching circuit 15 is connected between the switch 6 and the second filter 31 and matches the impedance between the switch 6 and the second filter 31. The matching circuit 16 is connected between the second power amplifier 33 and the second filter 31 and matches the impedance between the second power amplifier 33 and the second filter 31.

### (2) Operation

An operation of the radio frequency module 1 according to the exemplary embodiment 2 is described. In the exemplary embodiment 2, it is assumed that the second communication band and the third communication band are configured so as not to be able to establish communication concurrently. Additionally, it is assumed that the first communication band and the second communication band are configured so as not to be able to establish communication concurrently.

(2-1) Operation when Communication (i.e., Transmitting) is Established by Using First Communication Band

A case where communication (e.g., transmitting) is established by using the first communication band is considered with reference to FIG. 6. In this case, as with the case of the exemplary embodiment 1, since the first communication band and the second communication band are configured so as not to be able to establish communication concurrently, the signal used in the communication (the transmission signal) does not include the signal in the second communication band.

In this case (when transmitting is performed by using the first communication band), the switch 6 is switched to the first connection. In the first connection, the common terminal 6a is connected to only the first selection terminal 6b out of the first selection terminal 6b and the second selection terminal 6c. Thus, a transmission signal S5 inputted from the signal processing circuit 2 to the external terminal 5b flows from the external terminal 5b to the first selection terminal 6b of the switch 6 through the first communication path L1. In this case, the transmission signal S5 passes through the first power amplifier 32, the matching circuit 14, the first filter 30, and the matching circuit 13 in sequence. In this case, the transmission signal S5 is amplified by the first power amplifier 32. And then the transmission signal S5 is limited to the signal in the first communication band and the second communication band by the first filter 30. To be more specific, in this case (a case where transmitting is performed by using the first communication band), since the transmission signal S5 does not include the signal in the second communication band as the signal used in the communication, the transmission signal S5 is limited to the signal in the first communication band. Then, the transmission signal S5 is transmitted from the antenna 3 to the outside through the first selection terminal 6b and the common terminal 6a of the switch 6 and the external terminal 5a.

In this operation description, it is assumed that the band width of the second communication band is sufficiently smaller than the band width of the first communication band. Under this assumption, the spurious wave in the second communication band, which is along with the signal in the first communication band being used in the communication, is small enough to be ignored.

Thus, when transmitting is performed by using the first communication band, the transmission signal S5 limited to the signal in the first communication band by the first filter 30 flows through the first communication path L1.

(2-2) Operation when Transmitting is Performed by Using Second Communication Band

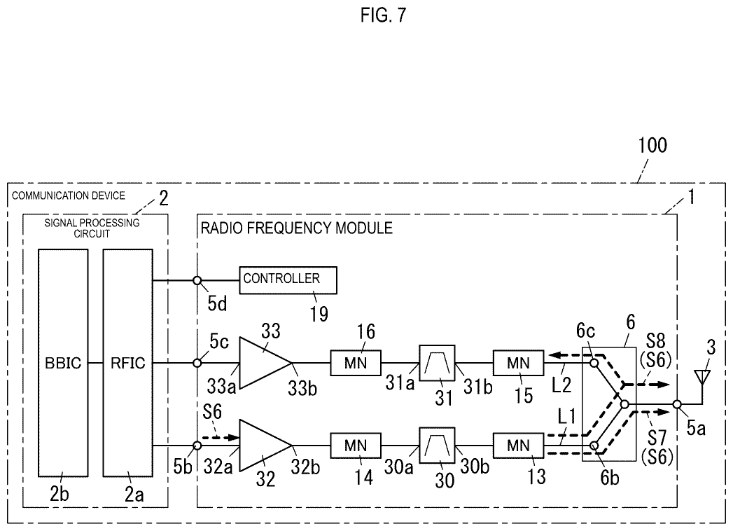

A case where transmitting is performed by using the second communication band is considered with reference to FIG. 7. In this case, the switch 6 is switched to the second connection. In the second connection, the common terminal 6a is connected to both the first selection terminal 6b and second selection terminal 6c. Thus, a transmission signal S6 from the signal processing circuit 2 flows from the external terminal 5b to the first selection terminal 6b and then the common terminal 6a of the switch 6 through the first communication path L1. In this case, the transmission signal S6 passes through the first power amplifier 32, the matching circuit 14, the first filter 30, and the matching circuit 13 in sequence. In this case, the transmission signal S6 is amplified by the first power amplifier 32 and limited to the signal in the first communication band and the second communication band by the first filter 30. Then, the transmission signal S6 can flow from the common terminal 6a to an external terminal 5a side (an antenna 3 side) and also can flow from the common terminal 6a to a second selection terminal 6c side (a second filter 31 side).

Incidentally, at least a part of the third communication band overlaps the first communication band, but the third communication band does not overlap the second communication band. Therefore, a signal S7 in the second communication band that is included in the transmission signal S6 can pass through the first filter 30 having the pass band that includes the second communication band but cannot pass through the second filter 31 having the pass band that does not include the second communication band. Therefore, the signal S7 in the second communication band that is included in the transmission signal S6 does not flow from the common terminal 6a of the switch 6 to the second selection terminal 6c side (i.e., the second filter 31 side) but flows from the common terminal 6a to the external terminal 5a side (i.e., the antenna 3 side).

In the exemplary embodiment 2, the first communication band and the second communication band are configured so as not to be able to establish communication concurrently as with the exemplary embodiment 1. Therefore, in this case (a case where transmitting is performed by using the second communication band), the transmission signal S6 does not include the signal in the first communication band as the signal used in the communication but may include a spurious wave S8 in the first communication band. The spurious wave S8 in the first communication band that is included in the transmission signal S6 can pass through the second filter 31 having the pass band including the third communication band in which at least a part thereof overlaps the first communication band. Therefore, the spurious wave S8 in the first communication band that is included in the transmission signal S6 flows dispersedly from the common terminal 6a of the switch 6 to both the external terminal 5a side (the antenna 3 side) and second selection terminal 6c side (the second filter 31 side). That is, since a part of the spurious wave S8 in the first communication band that is included in the transmission signal S6 is dispersed to the second selection terminal 6c side (the second filter 31 side), the spurious wave S8 in the first communication band that is included in the transmission signal S6 flowing to the external terminal 5a side (the antenna 3 side) is accordingly reduced.

Thus, when communication (e.g., transmitting) is established by using the second communication band, the signal S7 in the second communication band that is included in the transmission signal S6 flows from the common terminal 6a of the switch 6 to only the external terminal 5a side out of the external terminal 5a side and the second selection terminal 6c side. On the other hand, the spurious wave S8 in the first communication band that is included in the transmission signal S6 flows dispersedly from the common terminal 6a of the switch 6 to both the external terminal 5a side and second selection terminal 6c side. Thus, it is possible to reduce the spurious wave S8 in the first communication band, which flows along with the signal S7 in the second communication band, in the external terminal 5a. That is, it is possible to sufficiently secure attenuation of the spurious wave S8 in the first communication band, which is along with the signal in the second communication band being used in the communication. Thus, it is possible to reduce the above-described spurious wave, which is along with the signal S7 in the second communication band, and therefore it is possible to expand the pass band of the first filter 30 to include the second communication band.

### (3) Effect

According to the radio frequency module 1 according to the exemplary embodiment 2, as with the exemplary embodiment 1, it is possible to achieve both the improvement of attenuation of the spurious wave S8 and size reduction also in the configuration in which the first amplifier and the second amplifier are the first power amplifier 32 and the second power amplifier 33, respectively.

Additionally, in the radio frequency module 1 according to the exemplary embodiment 2, the first communication band includes the transmission band of the Band 12. The second communication band includes the transmission band of the Band 71. The third communication band includes the transmission band of the Band 28.

According to this configuration, as with the exemplary embodiment 1, it is possible to achieve both the improvement of attenuation of the spurious wave S8 and size reduction also when the first communication band includes the transmission band of the Band 12, the second communication band includes the transmission band of the Band 71, and the third communication band includes the transmission band of the Band 28.

### (4) Modification

The exemplary embodiment 2 may be implemented with the exemplary embodiment 1 and the modifications 1 and 2 thereof in combination.

### Aspects

The present specification discloses the following aspects.

The radio frequency module (1) of a first aspect includes the switch (6), the first communication path (L1), the second communication path (L2), the first filter (7;30), and the second filter (8;20;31). The switch (6) includes the common terminal (6a), the first selection terminal (6b), and the second selection terminal (6c). The first communication path (L1) is connected to the first selection terminal (6b). The second communication path (L2) is connected to the second selection terminal (6c). The first filter (7;30) is provided in the first communication path (L1) and has the pass band including the first communication band and the second communication band different from each other. The second filter (8;20;31) is provided in the second communication path (L2) and has the pass band including the third communication band. At least a part of the third communication band overlaps the first communication band, and the third communication band does not overlap the second communication band. The switch (6) is configured to be switchable between the first connection and the second connection. In the first connection, the common terminal (6a) and the first selection terminal (6b) are connected to each other, and the common terminal (6a) and the second selection terminal (6c) are not connected to each other. In the second connection, the common terminal (6a) and the first selection terminal (6b) are connected to each other, and the common terminal (6a) and the second selection terminal (6c) are connected to each other. The second communication band and the third communication band are configured so as not to be able to establish communication concurrently.

According to this configuration, when the switch (6) selects the second connection, and communication (transmitting or receiving) is established by using the second communication band, it is possible to disperse a part of the spurious wave (S3;S8) in the first communication band, which is along with the signal (S2;S7) in the second communication band being used in the communication, from the common terminal (6a) to the second filter (8;20;31) side (the second communication path (L2) side). To be more specific, in a case of receiving, it is possible to disperse the spurious wave (S3) included in the reception signal that arrives at the common terminal (6a) from the external terminal (5a) to the first filter (7) side (the first communication path (L1) side) and the second filter (8) side (the second communication path (L2) side) from the common terminal (6a). In a case of transmitting, it is possible to disperse the spurious wave (S8) included in the transmission signal that arrives at the common terminal (6a) through the first communication path (L1) to the second filter (8) side (the second communication path (L2) side) and the external terminal (5a) side from the common terminal (6a). Thus, when communication is established by using the second communication band, it is possible to reduce the above-described spurious wave (S3;S8), which is along with the signal (S2;S7) in the second communication band being used in the communication, with the switch (6) selecting the second connection. That is, it is possible to sufficiently secure attenuation of the spurious wave (S3;S8), which is along with the signal being used in the communication.

Additionally, since the communication path (i.e., the second communication path (L2) in which the second filter (8;20;31) is provided) used for the communication of the third communication band different from the first communication band and the second communication band is also used as the path to secure attenuation of the above-described spurious wave (S3;S8) as mentioned above, it is possible to reduce the radio frequency module (1) in size. As above, it is possible to achieve both the improvement of attenuation of the spurious wave (S3;S8) and size reduction.

Moreover, in the first aspect, the second communication band and the third communication band are configured so as not to be able to establish communication concurrently.

According to this configuration, when communication is established by using the second communication band, it is possible to disperse a part of the spurious wave (S3;S8) in the first communication band, which is along with the signal (S2;S7) in the second communication band being used in the communication, to the second filter (8) side that is not being used in the communication. Thus, it is possible to reduce a negative effect of the above-described spurious wave (S3;S8) dispersed to the second filter (8) side on the communication using the second communication band.

In the radio frequency module (1) of a second aspect, the first communication band and the second communication band are configured so as not to be able to establish communication concurrently in the first aspect.

According to this configuration, since it is possible to use the filter (the first filter (7, 30)) having the pass band including the first communication band and the filter (the first filter (7,30)) having the pass band including the second communication band as one filter, it is possible to implement size reduction of the radio frequency module (1). Additionally, when communication is established by using the second communication band, even if a part of the signal in the first communication band, which is along with the signal (S2;S7) in the second communication band being used in the communication, is dispersed to the second filter (8;20;31) side as the spurious wave (S3;S8), it is possible to reduce a negative effect on the communication using the first communication band.

The radio frequency module (1) of a third aspect further includes the first amplifier (10;32) in the first or second aspect. The first amplifier (10;32) is provided on the opposite side of the first filter (7;30) from the switch (6) in the first communication path (L1).

According to this configuration, in the configuration in which the first amplifier (10;32) is provided in the first communication path (L1), it is possible to achieve the effects of improvement of attenuation of the spurious wave (S3;S8) and size reduction described above.

The radio frequency module (1) of a fourth aspect further includes the second amplifier (11;33) in any one of the first to third aspects. The second amplifier (11;33) is provided on the opposite side of the second filter (8;20;31) from the switch (6) in the second communication path (L2).

According to this configuration, in the configuration in which the second amplifier (11;33) is provided in the second communication path (L2), it is possible to achieve the effects of improvement of attenuation of the spurious wave (S3;S8) and size reduction described above.

The radio frequency module (1) of a fifth aspect further includes the matching circuit (13,14) in the third aspect. The matching circuit (13,14) is provided in at least one of a portion between the switch (6) and the first filter (7;30) and a portion between the first filter (7;30) and the first amplifier (10;32) in the first communication path (L1).

According to this configuration, it is possible to adjust the impedance characteristics of the first communication path (L1) by the matching circuit (13,14). Thus, when the switch (6) selects the second connection, it is possible to adjust a ratio of a part of the spurious wave (S3;S8) in the first communication band that is dispersed to the second filter (8;20;31) side.

The radio frequency module (1) of a sixth aspect further includes the matching circuit (15,16) in the fourth aspect. The matching circuit (15,16) is provided in at least one of a portion between the switch (6) and the second filter (8;20;31) and a portion between the second filter (8;20;31) and the second amplifier (11;33) in the second communication path (L2).

According to this configuration, it is possible to adjust the impedance characteristics of the second communication path (L2) by the matching circuit (15,16). Thus, when the switch (6) selects the second connection, it is possible to adjust a ratio of a part of the spurious wave (S3;S8) in the first communication band that is dispersed to the second filter (8;20;31) side.

In the radio frequency module (1) of a seventh aspect, the switch (6) further includes the third selection terminal (6d) in any one of the first to sixth aspects. The radio frequency module (1) further includes the third communication path (L3) and the third filter (9). The third communication path (L3) is connected to the third selection terminal (6d). The third filter (9) is provided in the third communication path (L3).

According to this configuration, in the configuration further including the third filter (9) in addition to the first filter (7) and the second filter (8), it is possible to achieve both the improvement of attenuation of the spurious wave (S3) and size reduction described above.

In the radio frequency module (1) of an eighth aspect, the second filter (20) is the FDD filter in any one of the first to seventh aspects.

According to this configuration, when the second filter (20) is the FDD filter, it is possible to achieve both the improvement of attenuation of the spurious wave (S3) and size reduction described above.

In the radio frequency module (1) of a ninth aspect, the first communication band is the Band 41 in any one of the first to seventh aspects. The second communication band is the Band 53. The third communication band is the reception band of the Band 7.

According to this configuration, when the first communication band is the Band 41, the second communication band is the Band 53, and the third communication band is the reception band of the Band 7, it is possible to achieve both the improvement of attenuation of the spurious wave (S3) and size reduction described above. Particularly, since the third communication band is the reception band of the Band 7, it is possible to improve attenuation of the interference wave in the OOB blocking Range 3 as the spurious wave (S3).

In the radio frequency module (1) of a tenth aspect, the first communication band includes the transmission band of the Band 12 in any one of the first to seventh aspects. The second communication band includes the transmission band of the Band 71. The third communication band includes the transmission band of the Band 28.

According to this configuration, when the first communication band includes the transmission band of the Band 12, the second communication band includes the transmission band of the Band 71, and the third communication band includes the transmission band of the Band 28, it is possible to achieve both the improvement of attenuation of the spurious wave (S8) and size reduction described above.

The communication device (100) of an eleventh aspect includes the radio frequency module (1) in any one of the first to tenth aspects and the signal processing circuit (2). The signal processing circuit (2) is connected to the radio frequency module (1) and processes the radio frequency signal.

According to this configuration, it is possible to provide the communication device (100) that can achieve the above-described effects of the radio frequency module (1).

What is claimed is:

1. A radio frequency module comprising:
a switch that includes a common terminal, a first selection terminal, and a second selection terminal;
a first communication path that is connected to the first selection terminal;
a second communication path that is connected to the second selection terminal;
a first filter that is provided in the first communication path and includes a pass band including a first communication band and a second communication band different from the first communication band; and
a second filter that is provided in the second communication path and includes a pass band including a third communication band in which at least a part thereof overlaps the first communication band but does not overlap the second communication band, wherein
the switch is configured to be switchable between first connection and second connection,
in the first connection, the common terminal is connected to the first selection terminal, and the common terminal is not connected to the second selection terminal,
in the second connection, the common terminal is connected to the first selection terminal, and the common terminal is connected to the second selection terminal, and
the second communication band and the third communication band are configured not to be able to establish communication concurrently.

2. The radio frequency module according to claim 1, wherein
the first communication band and the second communication band are configured not to be able to establish communication concurrently.

3. The radio frequency module according to claim 1, further comprising:
a first amplifier that is provided on an opposite side of the first filter from the switch in the first communication path.

4. The radio frequency module according to claim 3, further comprising:
a second amplifier that is provided on an opposite side of the second filter from the switch in the second communication path.

5. The radio frequency module according to claim 3, further comprising:
a matching circuit that is provided in at least one of a portion between the switch and the first filter and a portion between the first filter and the first amplifier in the first communication path.

6. The radio frequency module according to claim 4, further comprising:
a matching circuit that is provided in at least one of a portion between the switch and the second filter and a portion between the second filter and the second amplifier in the second communication path.

7. The radio frequency module according to claim 1, wherein
the switch further includes a third selection terminal, and
the radio frequency module further comprises:
a third communication path that is connected to the third selection terminal; and
a third filter that is provided in the third communication path.

8. The radio frequency module according to claim 1, wherein
the second filter is a frequency division duplex (FDD) filter.

9. The radio frequency module according to claim 1, wherein
the first communication band is a Band 41,
the second communication band is a Band 53, and
the third communication band is a reception band of a Band 7.

10. The radio frequency module according to claim 1, wherein
the first communication band includes a transmission band of a Band 12,
the second communication band includes a transmission band of a Band 71, and
the third communication band includes a transmission band of a Band 28.

11. A communication device comprising:
the radio frequency module according to claim 1; and
a signal processing circuit that is connected to the radio frequency module and processes a radio frequency signal.

12. A communication device comprising:
the radio frequency module according to claim 2; and
a signal processing circuit that is connected to the radio frequency module and processes a radio frequency signal.

13. The radio frequency module according to claim 2, further comprising:
a first amplifier that is provided on an opposite side of the first filter from the switch in the first communication path.

14. The radio frequency module according to claim 2, wherein
the switch further includes a third selection terminal, and
the radio frequency module further comprises:
a third communication path that is connected to the third selection terminal; and
a third filter that is provided in the third communication path.

15. The radio frequency module according to claim 2, wherein
the second filter is a frequency division duplex (FDD) filter.

16. The radio frequency module according to claim 2, wherein
the first communication band is a Band 41,
the second communication band is a Band 53, and
the third communication band is a reception band of a Band 7.

17. The radio frequency module according to claim 2, wherein
the first communication band includes a transmission band of a Band 12,
the second communication band includes a transmission band of a Band 71, and
the third communication band includes a transmission band of a Band 28.

18. The communication device according to claim 11, wherein the signal processing circuit includes a radio frequency (RF) processing circuit to upconvert transmit signals and to downconvert received signals, and a baseband processing circuit to process the received signal after downconversion by the RF circuit and to provide the RF circuit with the transmit signal for upconversion.

19. The communication device according to claim 12, wherein the signal processing circuit includes a radio frequency (RF) processing circuit to upconvert transmit signals and to downconvert received signals, and a baseband processing circuit to process the received signal after downconversion by the RF circuit and to provide the RF circuit with the transmit signal for upconversion.
